(19) United States
(12) Patent Application Publication
(10) Pub. No.: US 2007/0059509 A1
(43) Pub. Date: Mar. 15, 2007

(54) Process for imparting water resistance to wood-based products

(76) Inventor: Maria Racota, Ontario (CA)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/224,121

(22) Filed: Sep. 13, 2005

(51) Int. Cl. B05D 3/02; B32B 21/02

(52) U.S. Cl. 428/292.4; 427/393; 427/397

(57) ABSTRACT

A process for preparing water resistant wood-based panels is disclosed. The process comprises the application of a latex-free wax emulsion to a mat of wood strands and adhesive before the application of heat and pressure to form said wood-based panel, or the application of said latex-free wax emulsion to a wood-based panel and allowing said composition to dry.

### FIELD OF THE INVENTION

The present invention relates to a process for sealing porous substrates, including wood or wood-based products, to prevent or inhibit water absorption.

### DESCRIPTION OF THE PRIOR ART

Many building construction materials are prepared with wood-based materials However, as the supply of wood has shrunk due to the gradual depletion of forests, solid wood lumber has become so expensive that it has become common to use small trees or scrap wood in wood-based composite materials such as plywood and engineered wood products. Engineered wood products include laminated wood composites. Types of laminated wood composites include laminated veneer lumber (“LVL”) and oriented strand board (“OSB”) panels.

LVL and OSB panels are prepared by applying an adhesive to strips, chips, flakes or sheets of wood (collectively, “strands”) to form a sheet, board, or panel. In OSB, the external layers are aligned in one direction and the internal layers are composed of randomly positioned strands. To prepare OSB, strands of wood are aligned and adhesive is added to bond the strands together, forming a mat. In LVL, multiple thin strips wood are layered into a mat or board and bonded with an adhesive. In both LVL and OSB, the mat is then compressed under high temperature in a heated (thermal) press. This process dries or “cures” the adhesive. The laminated panels can be further heated in a kiln, or kept in the thermal press, to finish curing of the adhesive, remove all moisture and increase overall hardness of the panel.

LVL and OSB panels are used for many parts of building construction, such as the subfloor, sidings or roof. As construction of a building can take place over a long period of time, the wood composite panels and boards are exposed to the environment while the building is completed. The panels must be resistant to variable environmental conditions, particularly water exposure, to allow the building to retain its structural integrity, both during and after construction. This is particularly true when the panels are used for flooring, and can be exposed to pooling water.

Wood-based panels such as LVL and OSB are susceptible to water absorption. The major faces of the panels are less susceptible to water absorption, as the panel faces are generally composed of sheets of wood that are relatively non-porous. However, water can be absorbed by the adhesive bonding the strands of wood within the panel, causing degradation of the panel. Also, the edges of wood composite panels are highly porous and therefore susceptible to water absorption.

Wood composite panels which absorb water have a negative effect on the stability and integrity of the building structure, as the panels tend to swell and thicken, causing the panel to buckle and shift from its original position. Also, the adhesive holding together the strands of wood within the panel can absorb water and lead to panel disintegration. If the panels are used for flooring, water can pool between each panel. The edges of each panel can then absorb water. If the edges of the panels absorb water, the edges expand, forming ridges in the floor, which must then be sanded down. Moreover, wood panels that have swelled with water do not return to their original shape after drying, often retaining the fully swelled shape.

Water repellent or waterproofing compositions are typically used to prevent penetration of water into wood-based panels. Hydrophobic compositions that form a water-repellent or water-impermeable (“waterproof”) barrier can be applied to the major faces and the edges of the wood panels to prevent water absorption.

Wood sealing compositions (“sealants”) are commonly prepared from hydrocarbons, including latex emulsions or hydrophobic wax/oil, that form a water-repellent or waterproof barrier on the wood surface. One method of applying a hydrophobic coating is to apply a composition of uncross-linked hydrocarbon monomers to the substrate and then cross-linking the monomers to form a hydrophobic polymer coating. Another common composition for sealing wood is an emulsion of hydrophobic particles, including polymer latex or wax/oil, in a water or aqueous base. Upon application, the aqueous content of the emulsion evaporates, leaving a continuous coating of the hydrophobic particles on the substrate.

Examples of compositions, including wax emulsions, for sealing wood are known in the art. Such examples include U.S. Pat. No. 3,180,750, U.S. Pat. No. 5,468,284 and U.S. Pat. No. 6,428,902. Compositions for specific use as edge sealants of wood-based panels are also known in the art. U.S. Pat. No. 3,180,750 describes a water repellent composition for waterproofing fibrous materials, including wood. The disclosed composition comprises a mixture of a fatty ketone and a polymeric wax, preferably formulated as an emulsion. U.S. Pat. No. 5,468,284 describes an emulsion of starch, wax, and a quaternary ammonium in water, for waterproofing wood. U.S. Pat. No. 6,428,902 describes a wax, cationic surfactant, and an aqueous carrier to be applied under pressure and room temperature to penetrate below the surface of wood boards and panels.

Examples of edge sealing compositions include U.S. Pat. No. 6,558,748 and U.S. Pat. No. 6,608,131. U.S. Pat. No. 6,558,748 describes a process for forming a polyurea coating on a wood composite substrate, wherein an isocyanate is first applied to the edge of the wood composite, and a polymer latex is applied as a second coat. The reaction between the polymer latex and the isocyanate forms a polyurea coating on the wood composite. U.S. Pat. No. 6,608,131 describes an edge sealant composition comprising a butylacrylate latex, a solution of wax in oil, a surfactant, and water.

Emulsions comprising latex and wax are commonly used to seal wood-based products as the wax and latex together have a synergistic effect on the water sealing properties of the composition. The latex forms a sealing layer on the surface of the wood-based product while wax penetrates below the surface and into the pores of the wood-based product. As such, emulsions comprising latex and wax are useful for imparting water resistance to wood-based products such as LVL and OSB, and particularly for sealing the porous edges of LVL and OSB.

A common drawback of the sealing compositions found in the prior art is the tackiness of the hydrophobic particles within the compositions. This is a particular problem with emulsions such as aqueous-based latex emulsions and emulsions comprising latex and wax. As the aqueous component of the emulsion evaporates, the coating becomes very sticky as the hydrophobic particles become exposed to air. When wood panels are coated with the sealing composition, the coated surfaces of the wood panels typically stick together and to anything that may come in contact with the coated surfaces. The surfaces of the wood panels that have stuck together and dried are often damaged when pulled apart. As noted above, thermal presses are used to manufacture the laminated wood panels. The sealing composition tends to stick to the plates of the thermal press, and also cause the wood panels to stick to the plates. Production of the wood panels must then be halted so that the plates of the thermal press can be cleaned. This slows down production of the engineered wood products. In order to avoid these problems, the sealant would have to be applied after the manufacture of the wood-based panel. However, this adds an additional step to the production of the finished product. In addition, prior art sealing compositions tend to clog the equipment used to apply the sealants.

Manufacture of wood-based products is typically a continuous process that occurs, for example, on conveyor belts which transfer the wood products from one step to the next. A related drawback of commonly used sealants is that they must be applied to the finished wood-based panels at the end of the manufacturing process, thus adding at least one separate and additional step after the manufacturing process. This adds to the cost and time of the manufacturing process. For example, in U.S. Pat. No. 6,558,748 noted above, the disclosed sealant must be applied in two additional, separate steps after the manufacture of the finished wood-based panel. Furthermore, if the panels stick together after application of the sealant, additional processing steps would be required to separate the panels and prepare them for marketability.

Accordingly, there is a need for an alternative process that overcome the above-noted drawbacks. It would desirable to have a composition that can be readily applied during the manufacture of the wood-based panel in order to obtain a manufacturing process that is continuous. It would also be desirable to have a process wherein the sealing composition that is used is not overly tacky, and does not cause the coated wood panels to stick to other objects, including other wood panels, and the equipment used to prepare the panels and apply the sealing composition.

### SUMMARY OF THE INVENTION

The present invention is directed to a process of preparing a water resistant wood-based panel comprising:
forming a mat of a mixture of wood strands and an adhesive;
pressing said mat and applying heat and pressure to said mat to form a wood-based panel;
applying a latex-free wax emulsion composition to surfaces of said mat or said panel;
drying said composition on said surfaces of said mat or said panel.

In a broad aspect of the invention, in the process of preparing the water resistant wood-based panel, the latex-free wax emulsion composition is applied to the mat of the mixture strands and adhesive before pressing said mat and applying heat and pressure.

In another broad aspect of the invention, in the process of preparing the water resistant wood-based panel, the latex-free wax emulsion composition is applied to the wood-based panel following the pressing of the mat of wood strands and adhesive and application of heat and pressure. In a preferred embodiment of this aspect of the invention, the emulsion composition is dried following the pressing of said mat. In yet another preferred embodiment of the invention, the emulsion composition is applied prior to the panel being cooled to below 100° C., whereby drying of said composition is promoted.

In another broad aspect of the invention, the latex-fee wax emulsion composition comprises:
a wax;
an emulsifier;
a stabilizing agent; and
water.
   The wax in the composition can be selected from the group consisting of scale wax, slack wax and paraffin wax. In a preferred embodiment of the invention, the wax in the composition has a melting point of about 40° C. 80° C. In yet another preferred embodiment of the invention, the wax comprises 10% to 60% w/w of said emulsion composition.

In yet another embodiment of the invention, the latex-free wax emulsion composition can further comprise one or more of the following additives:
a defoaming agent;
a thickening agent;
a corrosion inhibitor;
a preservative; or
water.

In another preferred embodiment of the invention, the latex-free wax emulsion composition has viscosity from about 200 to 250 cps.

In a preferred embodiment of the invention, wood-based panels comprise engineered wood products. Engineered wood products comprise oriented strand board (“OSB”), laminated veneer lumber (“LVL”), waferboard, chipboard, fiberboard and plywood.

An advantage of the present invention is low tackiness of the latex-free wax emulsion composition upon application to a surface. Because of the low tackiness of the composition, surfaces that have been treated with the composition do not stick to any other surfaces. Furthermore, the equipment used to apply the composition is not readily clogged with accumulated, dried sealant. This property of the sealing composition aids in cost and time saving of the manufacturing process of wood-based products.

Another advantage of the present invention is stability of the composition at high temperatures typically encountered during the manufacture of wood-based products including engineered wood products. The composition can be applied at high temperatures, thus allowing the step of applying of the composition to be easily incorporated into a manufacturing process. The process of the invention facilitates continuity in the manufacturing of wood-based products such as LVL and OSB, as the composition for imparting water-resistance can be applied before or after pressing and application of heat and pressure to the mat of wood strands and adhesive.

Other and further advantages and features of the invention will become apparent to those skilled in the art from the following detailed description of embodiments thereof.

### DETAILED DESCRIPTION OF THE INVENTION

In order that the invention may be more fully understood, it will now be described, by way of example of various embodiments of the invention.

In a broad aspect of the invention, there is provided a process for preparing a water resistant wood-based panel comprising:
forming a mat of a mixture of wood strands and an adhesive;
pressing said mat and applying heat and pressure to said mat to form a wood-based panel;
applying a latex-free wax emulsion composition to surfaces of said mat or said panel;
drying said composition on said surfaces of said mat or said panel.
   The composition comprises an aqueous-based emulsion of wax that is formulated without latex. The composition can additionally comprise other hydrophobic compounds. When applied to a porous substrate such as a wood-based panel, the aqueous component of the composition will evaporate, leaving a layer of wax deposited on the substrate which imparts water-resistance to the substrate.

In the process of the present invention, the wax emulsion composition is applied to the mat of wood strands and adhesive before pressing the mat to form a wood-based panel. The wax emulsion can also be applied to the wood-based panels which are formed following the application of heat and pressure. As used herein, the term “panels” will be assumed to refer to sheets (such as for example: 4′×8′×½″) as well as other pressed products such as beams and the like. Further the term “strands” will be used to refer to any type of wood pieces used in manufacturing “panels”.

As noted previously, emulsions comprising latex and wax are commonly used to impart water-resistance to wood-based products, such as LVL and OSB, due to the synergistic effect of the combination of latex and wax. However, emulsions comprising latex and wax tend to be sticky and do not readily allow for a continuous manufacturing process. The process of the invention allows for a continuous manufacturing process of wood-based panels, wherein the composition for imparting water-resistance can be applied before or after the application of heat and pressure to the mats of wood strands and adhesive.

In a broad aspect of the present invention, there is provided a sealing composition for sealing a porous material, comprising a wax emulsion, said wax emulsion comprising:
a wax;
an emulsifier;
a stabilizing agent; and
water.

As indicated above, the composition of the present invention is suited for application to porous substrates. Such porous substrates preferably include, but are not limited to, wood and wood-based products, including solid wood and also engineered wood products. Engineered wood products include LVL and OSB panels as described above.

The wax used in the preparation of the wax emulsion can comprise, for example, scale wax, slack wax or paraffin wax or any combination of such waxes. If scale wax is used, the scale wax can comprise an oil content of from 0 to about 30% w/w of the total scale wax weight.

Stabilizers are understood to be surfactants that stabilize emulsions and inhibit or prevent separation of the two immiscible phases. In the present invention, the two immiscible phases are wax and water. Stabilizers well known in the art can be used to stabilize the emulsion and prevent separation of the wax and water into separate phases. Examples of well known stabilizers include polyethylene glycol, and other derivatives of ethylene oxide polymers.

In a further preferred embodiment of the invention, the emulsifier comprises acid wax and a base. A suitable emulsifier comprises montanic acid wax and an amine base such as triethanolamine (TEA). Other examples of suitable bases that can be used include monoethanolamine (MEA) or morpholine.

The composition can further comprise one or more of the following:
defoaming agents
thickening agents;
corrosion inhibitors;
preservatives; or
water.

A defoaming agent is understood to be a surfactant which suppresses the formation of foam or fine bubbles in a composition. A defoaming agent can be added to the sealing composition of the present invention to facilitate the application of the composition. That is, the defoaming agent can be useful in preventing foaming while the composition is being sprayed. A suitable defoaming agent can be one or more silicone polymers. An example of a silicone polymer is polysiloxane, BYK 020™ (BYK-Chemie GmbH, Germany). Other suitable defoaming agents including, for example mineral oil and mineral oil derivatives, will be known to persons skilled in the art.

The composition can be applied with commonly used application apparatus, such as sprays, rollers or brushes. The composition has low enough viscosity to be easily pumped from a storage container, while having viscosity that is high enough to prevent the composition from dripping off the substrate. Particularly for spray applications, the viscosity is high enough to minimize overspray, which is wasted spray that does not contact the substrate, and still low enough to facilitate spraying of the composition. For application techniques including spraying and rollers, it is desirable to have a composition with viscosity of about 200 to about 250 cps, and a pH about pH 7.5 to about pH 8.5. However, it is understood that the viscosity of the sealing composition can be adjusted by addition of thickening agents, and the desired viscosity will depend on the technique chosen for applying the composition.

Thickening agents are understood to be high molecular weight polymers which increase the viscosity of the composition in which they reside. Suitable thickening agents for use in the sealing composition are compatible with aqueous-based emulsions. Such thickening agents include acrylic acid polymers, also known as carbomers. Other commonly used thickening agents well known in the art include cellulose derivatives and hydrophilic polymers.

The various polymers in the composition can be susceptible to attack by microorganisms such as bacteria and fungi. For this reason, in a preferred embodiment, the sealing composition of the present invention includes a preservative which is a microbicide. The microbicide inhibits growth of bacteria, fungi and algae in the composition. The microbicide can be present in an amount of from about 0.01 to about 1.0% w/w. A example of a suitable microbicide is 2-bromo-2-nitropropane-1,3-diol, however, various other preservatives will be known to persons skilled in the art.

Corrosion inhibitors can be added if required, in order to help prevent corrosion of the apparatus used to apply the sealing composition, and any other equipment that may come in contact with surfaces coated with the composition. A suitable corrosion inhibitor is sodium nitrite (NaNO₂), as it is water soluble and economical. However, various other anti-corrosion additives will be known to persons skilled in the art.

In a preferred aspect of the present invention, there is provided a wax emulsion composition comprising:
a wax having a melting point of from about 40° C. to about 80° C.;
emulsifier comprising acid wax and a base;
ethylene oxide polymer;
water.

In a preferred embodiment of the present invention, the composition can, in addition to the wax emulsion, further comprise one or more of the following:
siloxane polymer;
acrylic acid polymer or co-polymer;
corrosion inhibitor;
preservative.

Another advantage of the present invention is that the composition can be applied at temperatures of about 150° C. to about 160° C. As such, the sealing composition of the present invention can be applied at high temperatures. As noted above, engineered wood products are subjected to high temperatures during their manufacture. The sealing composition can therefore be applied during the manufacturing of engineered wood products such as LVL and OSB, including stages of the manufacturing process which occur at high temperature. Therefore, the process of the present invention can be made continuous, and can provide cost and time savings to the manufacturer.

Previous processes have not solved the problem of being able to easily apply the sealant composition during the manufacture of the engineered wood board, and in particular, before the final step of compression in a thermal press. An additional advantage of the composition of the present invention is that, once applied to a substrate surface and allowed to dry, the composition is not tacky during and after application of the composition to the substrate. Thus, surfaces that have been coated with the composition of the present invention do not stick to each other or to other surfaces. In particular, wood panels which have been coated with the composition of the present invention do not stick to the thermal press used to prepare wood-based panels, or any other surfaces which may come in contact with the composition. Thus, the composition can be applied to the surface of mats of wood strands before compression with the thermal presses to form the finished product. Therefore, the application of the composition can be incorporated into the process for preparing wood-based panels such that the process is continuous; a separate step to apply the sealant is not required after the preparation of the wood-based panels. Also, as the composition is not tacky upon application to the substrate, the coated wood panels do not stick together, and do not stick to the thermal press, nor does the composition clog the application equipment. The composition can be pumped, re-circulated, filtered and sprayed with commonly used application equipment, while the viscosity is high enough to minimize overspray. Thus, an advantage of the present invention is that the composition can be applied with equipment commonly used in building construction, including a spray system, a roller applicator, or a brush, and does not clog the application equipment.

Further details and advantages of the preferred embodiments of the preferred embodiments of the invention are illustrated in the following examples that are understood to be non-limiting with respect to the appended claims.

### EXAMPLE 1

A latex-free wax emulsion composition was prepared as follows.

The wax emulsion component of the composition was first prepared by mixing the components noted in Table 1 below. In order to form an emulsion, the components were mixed in a homogenizer at about 2000 to 4000 psi, at a temperature about 85° C. to 90° C.

TABLE 1
Wax Emulsion

| Component | Weight (kg) | % w/w of Total |
|---|---|---|
| Water | 758.27 | 43.2% |
| Triethanolamine (85% m/v aqueous | 20.34 | 1.1% |
| solution) | | |
| Carbowax ™ PEG 600 (Dow Chemical | 8.77 | 0.5% |
| Co., Michigan) | | |
| Licowax S ™ (Clariant Inc., Basel) | 36.83 | 2.1% |
| Paraffin wax (Purewax ™, Petro-Canada) | 929.42 | 53.0% |
| TOTAL | 1753.6 | 100% |

The wax emulsion thus prepared had a final theoretical solids content of 56.2%. The emulsion was adjusted to have pH 8-9 and viscosity less than 300 cps.

The composition was prepared using the wax emulsion as prepared in Table 1 and the additional components noted in Tables 2(a), 2(b) and 2(c).

TABLE 2(a)
Addition of silicone polymer defoaming agent and
preservative to wax emulsion.

| | | % w/w of Total |
|---|---|---|
| Component | Weight (kg) | in Table 2(c) |
| Wax emulsion | 1304.2 | 72.0% |
| Water | 54.3 | 3.0% |
| Polysiloxane, BYK 020 ™ | 1.8 | 0.1% |
| (BYK-Chemie GmbH, Germany) | | |
| Preservative, Biosperse ™ | 1.8 | 0.1% |
| 295 (Drew Chemicals, Ashland) | | |

The water, polysiloxane, and preservative of Table 2(a) were added to the wax emulsion of Table 1 with stirring or agitation under ambient conditions (room temperature, normal atmospheric pressure). A solution of sodium nitrite (NaNO₂) in water prepared according to Table 2(b) was added to the mixture of Table 2(a). All of the sodium nitrite (NaNO₂) was dissolved before the addition of the two mixtures of Tables 2(a) and 2(b) in order to have a homogeneous mixture.

TABLE 2(b)
Preparation of aqueous solution of sodium nitrite (NaNO₂).

| | | % w/w of Total |
|---|---|---|
| Component | Weight (kg) | in Table 2(c) |
| Sodium nitrite | 3.6 | 0.2% |
| Water | 54.3 | 3.0% |

Finally, the thickening agent and water of Table 2(c) were added to the mixture to form the composition.

TABLE 2(c)
Addition of thickening agent to mixture.

| | | % w/w of Total |
|---|---|---|
| Component | Weight (kg) | in Table 2(c) |
| Acrylic acid polymer, Acrysol ASE 60 | 27.2 | 1.5% |
| (Rohm and Haas Co., Philadephia) or | | |
| Dural P1172 (Dural, div. Multibond Inc., | | |
| Montreal) | | |
| Water | 364.1 | 20.1% |
| TOTAL | 1811.35 | 100% |

The final addition of water in Table 2(c) can be adjusted as desired to obtain the final viscosity and solids by weight in the above-noted preferred ranges. The composition was adjusted to a viscosity of about 200 to about 250 cps, and a pH about pH 7.5 to about 8.5

The composition thus prepared exhibited no phase separation or settling for storage periods of at least 3 months under ambient conditions. The viscosity of the composition was sufficient to allow easy application by pumping, filtering and spraying, while also minimizing overspray wastage.

### EXAMPLE 2

Sealing compositions of the prior art typically contain latex (for example, U.S. Pat. No. 6,608,131 as noted above) for forming a hydrophobic film on the surface of the substrate. The properties of a sealing composition containing latex, as described in Table 3, was compared to the properties of the composition of the present invention as described in Example 1.

TABLE 3
An example of a prior art sealing composition containing latex

| Component | Weight (kg) | % w/w of Total |
|---|---|---|
| Triethanolamine (85% m/v aqueous | 10.56 | 0.5% |
| solution) | | |
| Carbowax ™ PEG 600 | 4.80 | 0.3% |
| (Dow Chemical Co., Michigan) | | |
| Licowax S ™ (Clariant Inc., Basel) | 20.15 | 1.0% |
| Paraffin wax (Purewax ™, Petro-Canada) | 508.60 | 27% |
| Styrene polymer latex | 532.4 | 28.3% |
| Polysiloxane, BYK 020 ™ | 0.6 | 0.03% |
| (BYK-Chemie GmbH, Germany) | | |
| Preservative, Biosperse ™ | 1.92 | 0.1% |
| 295 (Drew Chemicals, Ashland) | | |
| Sodium nitrite | 2.82 | 0.2% |
| Diethylene glycol monobutyl ether | 48.92 | 2.6% |
| (Glycol Ether DB ™, | | |
| Lyondell Chemical Co., Texas) | | |
| Acrylic acid polymer, Acrysol ASE 60 | 62.09 | 3.3% |
| (Rohm and Haas Co., Philadephia) | | |
| Water | 687.70 | 36.5% |
| TOTAL | 1881.60 | 100% |

The amount of water in Table 3 can be adjusted as desired to obtain the preferred ranges in the final viscosity and solids by weight, according to the application technique used to apply the composition to the substrate. In this instance, the latex sealing composition preferably has a final viscosity of about 200 to about 250 cps, theoretical solids by weight about 39 to 41%, and about pH 7.5 to about pH 8.5.

The latex sealing composition was applied during the final stage of LVL board manufacture. The latex sealing composition was sprayed onto the major faces and edges of the LVL boards prior to application of the thermal press plates to the LVL boards. Within the thermal press, the temperature is maintained at about 150° C. to 160° C.; the non-heated area (the “cold zone”) of the press is about 25° C. to 30° C. It was noted that the LVL boards coated with the latex sealing composition stuck to the lower press plate, particular in the cold zone of the thermal press. Also, the spray apparatus was readily clogged with accumulated sealant. The manufacturing process was halted in order to remove the boards, clean the spray apparatus and the thermal press. It was also noted that the coatings on the boards was uneven, with areas of the boards containing too much sealant and other areas containing not enough sealant.

The sealing composition as prepared according to Example 1 was applied during the final stage of LVL board manufacture, using the same process as described above. It was noted that the coating of the boards was uniform. The coated boards did not stick to the thermal press plates, and the spray nozzles, used for spraying the sealing composition, remained clear and unplugged. The sealing composition of the invention did not readily accumulate on the equipment used to apply the composition. Moreover, the boards coated with the sealing composition of the invention had low tackiness upon application, and did not stick together. Thus, it was shown that the sealing composition of the present invention, which is latex-free, had a number of advantages over a sealing composition containing latex.

The sealing composition of Example 1 was also applied to the wood-based boards soon after the boards were removed from the thermal press, while the boards were about 120° C. In general, the sealing composition can be successfully applied at temperatures above 100° C. At this temperature, there was adequate time for the coated boards to dry so that the boards do not stick together before they are packaged. The heat of the boards aids the evaporation of the water component of the sealing composition. The boards are typically packaged when they have been cooled to a temperature of between about 50° C. to 60° C.

Various modifications, variations, and adaptations may be made to the particular embodiments of the invention described above without departing from the scope of the invention, which is defined in the following claims.

What is claimed is:

1. A process of preparing a water resistant wood-based panel comprising:
forming a mat of a mixture of wood strands and an adhesive;
pressing said mat and applying heat and pressure to said mat to form a wood-based panel;
applying a latex-free wax emulsion composition to surfaces of said mat or said panel;
drying said composition on said surfaces of said mat or said panel.

2. The process of claim 1 wherein said latex-free wax emulsion composition is applied to the mat of wood strands and adhesive before pressing said mat and applying heat and pressure.

3. The process of claim 1 wherein said latex-free wax emulsion composition is applied to said wood-based panel following the pressing of said mat and application of heat and pressure.

4. The process of claim 3 wherein said emulsion composition is applied prior to the panel being cooled to below 100° C. whereby drying of said composition is promoted.

5. The process of claim 1 wherein said latex-free wax emulsion composition comprises:
a wax;
an emulsifier;
a stabilizing agent; and
water.

6. The process of claim 3 wherein said wax is selected from the group consisting of scale wax, slack wax and paraffin wax.

7. The process of claim 3 wherein said wax has a melting point of about 40° C. to about 80° C.

8. The process of claim 5 wherein said wax comprises about 10% to 60% w/w of said emulsion composition.

9. The process of claim 1 wherein said latex-free wax emulsion composition further comprises one or more of the following additives:
a defoaming agent;
a thickening agent;
a corrosion inhibitor;
a preservative; or
water.

10. The process of claim 1 wherein said latex-free wax emulsion composition has viscosity of from about 200 to about 250 cps.

11. The water resistant wood panel prepared according to the process of claim 1.

12. The panel of claim 11 wherein said panel comprises an oriented strand board (OSB).

13. The panel of claim 11 wherein said panel comprises laminated veneer lumber (LVL).

14. A composition for imparting water resistance to engineered wood-based products comprising:
a wax;
an emulsifier;
a stabilizing agent; and
water.

15. The composition of claim 14 further comprising at least one or more of the following additives:
a defoaming agent;
a thickening agent;
a corrosion inhibitor;
a preservative; or
water.
